(19) United States
(12) Patent Application Publication
(10) Pub. No.: US 2008/0312928 A1
(43) Pub. Date: Dec. 18, 2008

(54) Natural language speech recognition calculator

(76) Inventors: Robert Patrick Goebel, Menlo Park, CA (US); Ravi Shivanna, San Jose, CA (US)

Correspondence Address: Ashok Tankha;Of Counsel, Lipton, Weinberger & Husick, 36 Greenleigh Drive, Sewell, NJ, 08080, US

(21) Appl. No.: 11/903,174

(22) Filed: Sep. 20, 2007

Related U.S. Application Data
(60) Provisional application No. 60/943,553, filed on Jun. 12, 2007.

(51) Int. Cl. G10L 15/00; G10L 15/26

(52) U.S. Cl. 704/255; 704/235; 704/E15.004

(57) ABSTRACT

Disclosed herein is a computer implemented method and system for evaluating a mathematical expression spoken in a natural language by a user. The disclosed method and system provides a natural language speech recognition calculator comprising a speech recognition engine. The spoken mathematical expression is transmitted to the speech recognition engine via an audio input device. Mathematical entities of the spoken mathematical expression are extracted and represented in a hierarchical recursive format of a speech recognition grammar implemented by the speech recognition engine. A symbolic mathematical expression is generated from the extracted mathematical entities and then normalized with common measurement units. The normalized mathematical expression is then evaluated to generate a mathematical result. The mathematical result may be synthesized by a text-to-speech engine to produce a voice output. The mathematical result may be provided on an audio output device, a video display unit, a printer, and an electronic device in a network.

### CROSS REFERENCE TO RELATED APPLICATIONS

This application claims the benefit of US provisional application No. 60/943,553 filed 12 Jun. 2007, titled “Natural Language Speech Recognition Calculator And Measurement Converter”.

### BACKGROUND

This invention, in general, relates to automated natural language speech recognition. More particularly, this invention relates to automated evaluation of spoken expressions that include basic and complex mathematical operations, numerical data, and measurement units.

Speech recognition and speech processing techniques have found widespread acceptance in an array of applications. The applications vary from entertainment oriented devices and automated voice response systems to security applications. However, the use of speech recognition and speech processing techniques for evaluating spoken mathematical expressions may be limited or absent.

In current art, speech processing techniques may be used in calculators to produce synthesize voice output from calculated mathematical results. Such talking calculators work as a conventional calculator with a synthesized speech output. However, the input to the talking calculator is entered by using a keypad or keyboard, and other input methods that do not involve speech inputs.

Speech recognition software is typically used for dictating text, issuing file operation commands such as create file, save file, etc. in computing devices. The speech recognition software may be biased towards file operations and other housekeeping functions of the computer system. Such speech recognition software may be unable to or have limited capabilities to process voice commands for performing mathematical calculations. As a result, the speech recognition software may be unable to evaluate spoken mathematical inputs involving complex mathematical operations, decimal numbers, fractions, complex numbers, etc.

Furthermore, spoken mathematical expressions may involve mathematical operations on quantities in different measurement units. These measurement units may be base units or derived units. For instance, distance between two places may be quantitatively expressed in units such as meter, mile, furlong, etc. The computing devices mentioned above may be unable to handle quantitative-representations of computational data that involves different measurement units. There is a need for appropriate measurement unit conversion before evaluating spoken mathematical expressions involving quantities with different measurement units,

Hence, there is an unmet need for a computer implemented method and system to automatically evaluate mathematical expressions spoken in a natural language by a user. Further, there is a need to evaluate spoken mathematical expressions comprising complex mathematical operations, arbitrary precision numbers, complex numbers, fractions, etc. Furthermore, there is a need to evaluate spoken mathematical expressions involving quantities with different measurement units.

### SUMMARY OF THE INVENTION

Disclosed herein is a computer implemented method and system for evaluating a mathematical expression spoken in a natural language by a user. The disclosed method and system addresses the above stated needs by automatically evaluating spoken mathematical expressions that include basic and complex mathematical operations, numbers such as decimal numbers, fractions, complex numbers, etc. and quantities with different measurement units, using a natural language speech recognition calculator.

A user utters a mathematical expression in a natural language into a microphone. The microphone is connected to a speech recognition engine of the natural language speech recognition calculator via the audio input device. The spoken mathematical expression is transferred from the audio input device to a speech recognition engine of the natural language speech recognition calculator. The user may select a natural language from a plurality of natural languages recognized by the speech recognition engine. The audio input device digitizes the speech signal and transfers the digitized speech signal to the speech recognition engine. The speech recognition engine accepts the continuous speech patterns and generates a sequence of words of the spoken mathematical expression from the digitized speech input signal. A user-dependent speech profile may be selected from a plurality of speech profiles to improve the accuracy of speech recognition of the speech recognition engine.

The speech recognition engine extracts mathematical entities from the spoken mathematical expression using a speech recognition grammar. The mathematical entities comprise numbers, mathematical operators, and measurement units. The speech recognition grammar implemented by the speech recognition engine provides a recursive representation of arbitrary numbers, mathematical operations, and measurement units. The mathematical entities of the spoken mathematical expression are represented in a hierarchical recursive structure of the speech recognition grammar. The natural language speech recognition calculator comprises an expression generator that generates a symbolic mathematical expression from the extracted mathematical entities.

The symbolic mathematical expression is then parsed and normalized with common measurement units. The natural language speech recognition calculator comprises a units converter for verifying the compatibility of measurement units present in the symbolic mathematical expression. The units converter converts the compatible measurement units to common measurement units. The normalized mathematical expression is then evaluated by an expression evaluator to generate a mathematical result. The mathematical result may be processed by a text-to-speech engine to convert the mathematical result into a voice output. The mathematical result may be provided to the user on one of an audio output device, video display unit, a printer, and an electronic device in a network.

In an embodiment of the disclosed computer implemented method and system, the natural language speech recognition calculator is implemented on a server device. The user uses a client device to communicate with the server device via a network. The spoken mathematical expression created by the user is transmitted from the client device to the server device as a client query via the network. The server device processes the client query and transmits the mathematical result as a query result back to the client device.

The computer implemented method and system disclosed herein, therefore, provides a natural language speech recognition calculator with speech recognition capabilities to evaluate complex mathematical expressions comprising numerical data, complex mathematical operations, and measurement units, spoken by a user in a natural language.

### BRIEF DESCRIPTION OF THE DRAWINGS

The foregoing summary, as well as the following detailed description of the embodiments, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of evaluating a mathematical expression spoken in a natural language by a user.

FIG. 2A illustrates a system for evaluating a mathematical expression spoken in a natural language by a user.

FIG. 2B illustrates a client-server embodiment of the system for evaluating a mathematical expression spoken in a natural language by a user.

FIG. 3 illustrates an exemplary block diagram of the speech recognition grammar implemented by the speech recognition engine of the natural language speech recognition calculator.

FIG. 4 illustrates an exemplary flowchart of the process of evaluating a mathematical expression spoken in a natural language by a user.

### DETAILED DESCRIPTION OF THE DRAWINGS

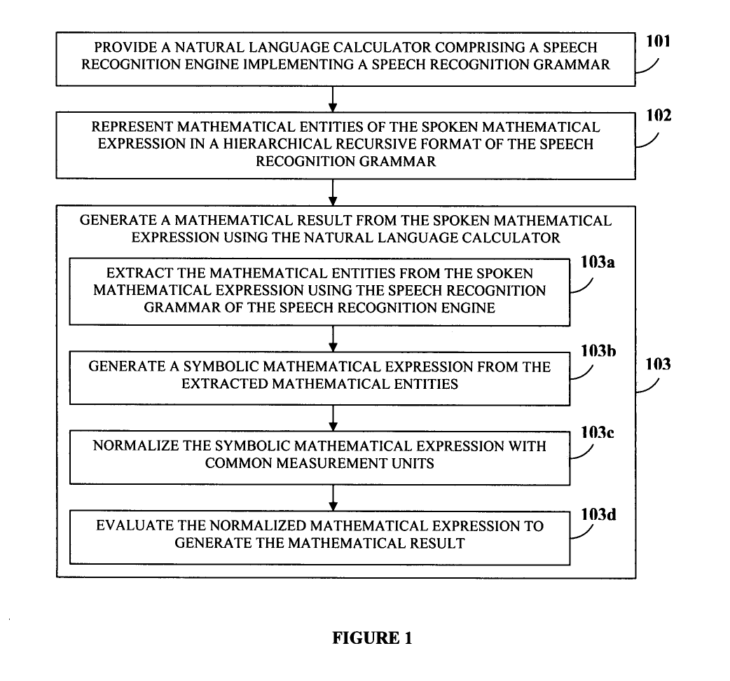

FIG. 1 illustrates a method of evaluating a mathematical expression spoken in a natural language by a user 201. The computer implemented method disclosed herein provides 101 a natural language speech recognition calculator 203 comprising a speech recognition engine 203a. The user 201 utters a mathematical expression spoken in a natural language into a microphone. The microphone is connected to the speech recognition engine 203a of the natural language speech recognition calculator 203 via an audio input device 202. The user 201 may select a natural language from a plurality of natural languages recognized by the speech recognition engine 203a of the natural language speech recognition calculator 203. For example, the speech recognition engine 203a may recognize natural languages such as English, French, Chinese, etc. Selecting a natural language enables the speech recognition engine 203a to recognize the language of the words in the spoken mathematical expression. A user-dependent speech profile may be selected from a plurality of speech profiles to improve the accuracy of speech recognition of the speech recognition engine 203a. The user-dependent speech profile comprises parameters related to the speech patterns of the user 201.

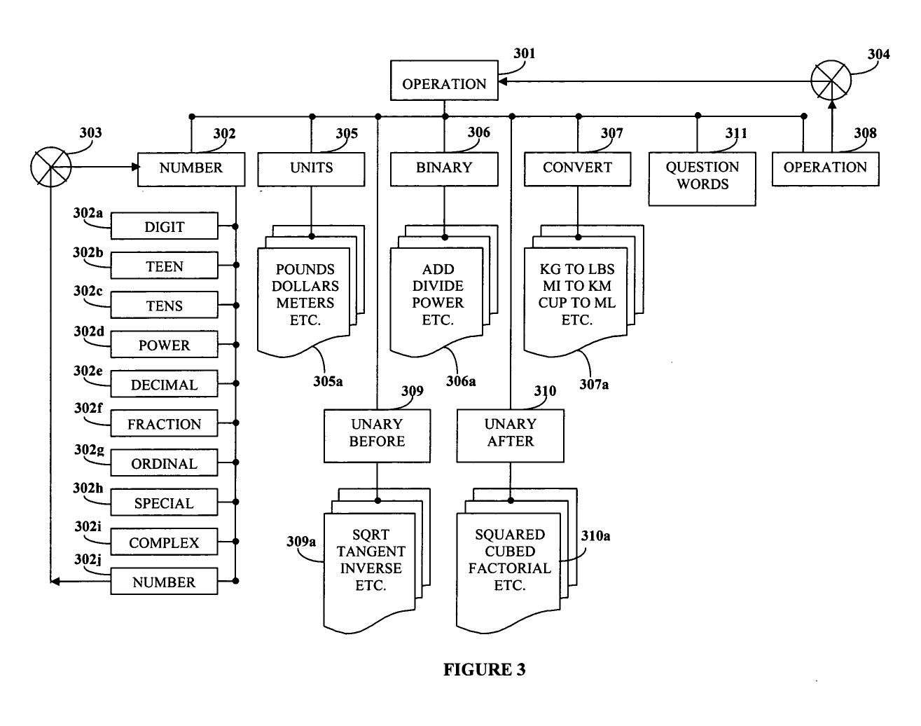

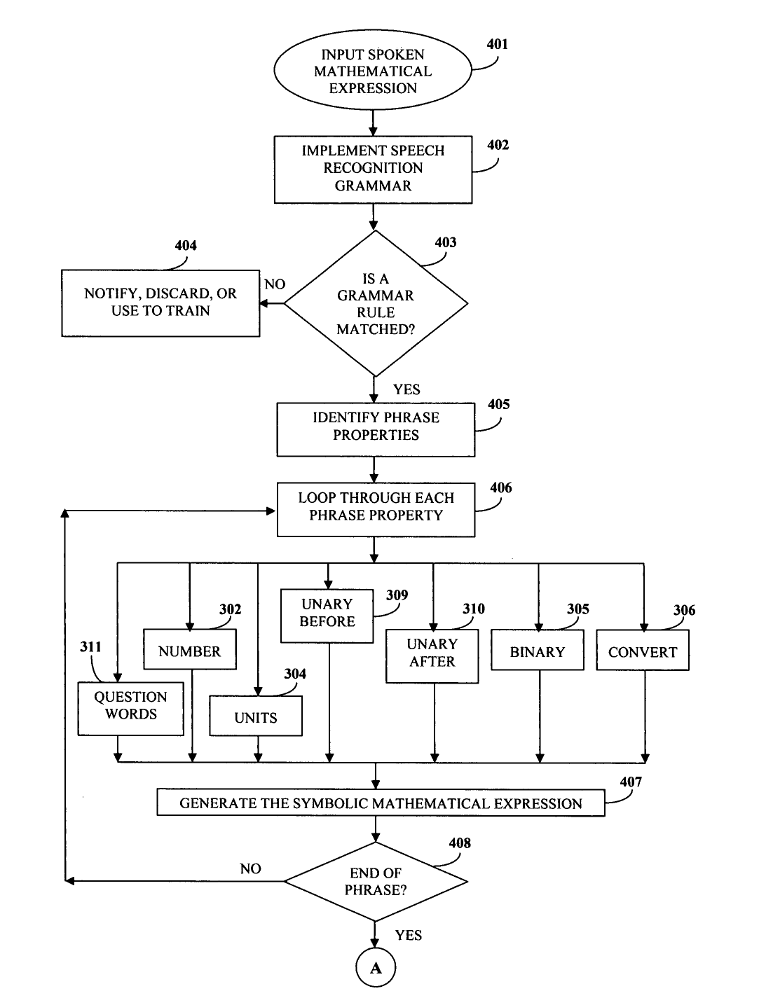

The microphone converts the spoken mathematical expression of the user 201 into an electrical speech signal and transfers the electrical speech signal to the audio input device 202. The audio input device 202 digitizes the electrical speech signal and transfers the digitized speech signal to the speech recognition engine 203a of the natural language speech recognition calculator 203. The natural language speech recognition calculator 203 generates 103 a mathematical result from the spoken mathematical expression as follows: The speech recognition engine 203a extracts 103a mathematical entities from the spoken mathematical expression using a speech recognition grammar. The mathematical entities comprise numbers, mathematical operators, and measurement units. The speech recognition grammar implemented by the speech recognition engine 203a provides a recursive representation of arbitrary numbers, mathematical operations, and measurement units as described in the detailed description of FIG. 3.

The speech recognition engine 203a uses the speech recognition grammar to recognize and extract arbitrary numbers including decimals, fractions, ordinals such as eleventh, thirteenth, etc. and complex numbers such as (5+2i), ( 3/7+⅖i), etc. The speech recognition engine 203a also recognizes and extracts words and phrases specifying mathematical operations such as ‘divided by’, ‘logarithm’, etc. and measurement units such as ‘dollars’, ‘pounds’, ‘miles’, ‘hours’, etc. For example, in the spoken mathematical expression, “How much is three point two nine pounds plus sixteen point six kilograms?”, the numbers 3.29 and 16.6, the addition operation ‘+’, and the units ‘pounds’ and ‘kilograms’ are recognized and extracted by the speech recognition engine 203a using the speech recognition grammar.

The mathematical entities of the spoken mathematical expression are represented 102 in a hierarchical recursive structure of the speech recognition grammar. A symbolic mathematical expression is generated 103b from the extracted mathematical entities. The symbolic mathematical expression is then parsed using a standard algorithm, for example, the shunting yard algorithm. This algorithm converts the symbolic mathematical expression into a reverse polish notation (RPN). The RPN is a mathematical notation wherein every operator of the mathematical expression follows the operands of the expression. This notation enables the mathematical expression to be evaluated accurately by taking into account the order and precedence of the mathematical operations. For example, the symbolic mathematical expression ‘2+4×7′ will be converted into 7 4×2+. The converted result indicates that ‘7’ will be multiplied by ‘4’ and then ‘2’ will be added to the result of multiplication because multiplication has a higher precedence than addition.

The parsed symbolic mathematical expression is then normalized 103c with common measurement units. If measurement units such as ‘dollars’ or ‘pounds’ are recognized in the spoken mathematical expression, the measurement units are verified for compatibility and converted to common measurement units. Derived units from products or divisions of measurement units may also be checked for compatibility. The compatibility of measurement units depends on the operations present in the spoken mathematical expression. For addition and subtraction operations, the measurement units must represent the same kind of quantity, such as weight or time. For example, ‘pounds’ and ‘kilograms’ are compatible for addition and subtraction, as ‘pounds’ may be converted to ‘kilograms’. Conversely, ‘pounds’ and ‘seconds’ are not compatible units and cannot be converted to a common measurement unit. Multiplication and division of units usually result in derived units. For example, ‘50 miles/2 hours’=‘25 miles per hour’.

Conversion of measurement units to common measurement units may be performed in the following ways: The compatible units may be converted into the first unit present in the spoken mathematical expression. For example, consider the spoken mathematical expression “What is three point six nine miles plus eighteen point seven three four kilometers?”. Since ‘miles’ is the first unit mentioned, the second unit ‘kilometers’ will be converted into miles before evaluating the expression. Conversion of values of arguments from one measurement unit to another may also be performed using a lookup table in a data file comprising all the common measurement unit conversion values. Derived units from products or divisions of measurement units may be called upon when the input mathematical expression contains products or divisions of dissimilar measurement units. For example, consider the spoken mathematical expression “What is fifty miles divided by two hours?” The derived units in the example will be ‘miles per hour’.

The normalized mathematical expression is then evaluated 103d to generate a mathematical result. The evaluation may be performed by built-in mathematical functions of a programming language. The mathematical result may then be converted to a voice output by a text-to-speech 203e engine. The mathematical result may also be provided to the user 201 on an output device 204 that is one of an audio output device, a video display unit, a printer, and an electronic device in a network.

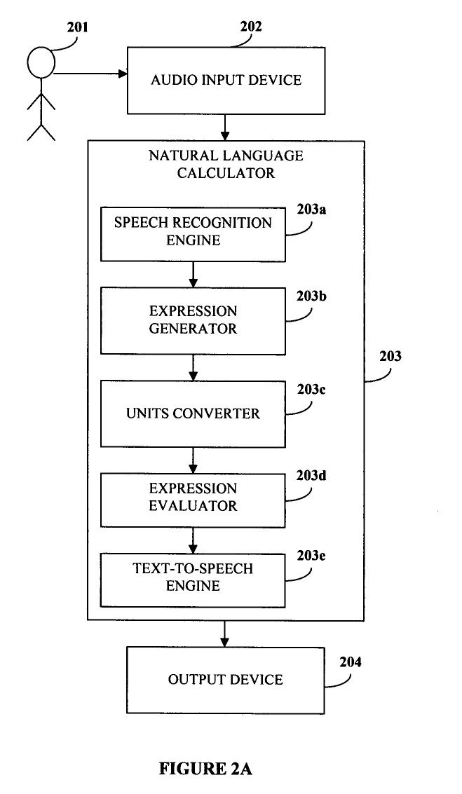

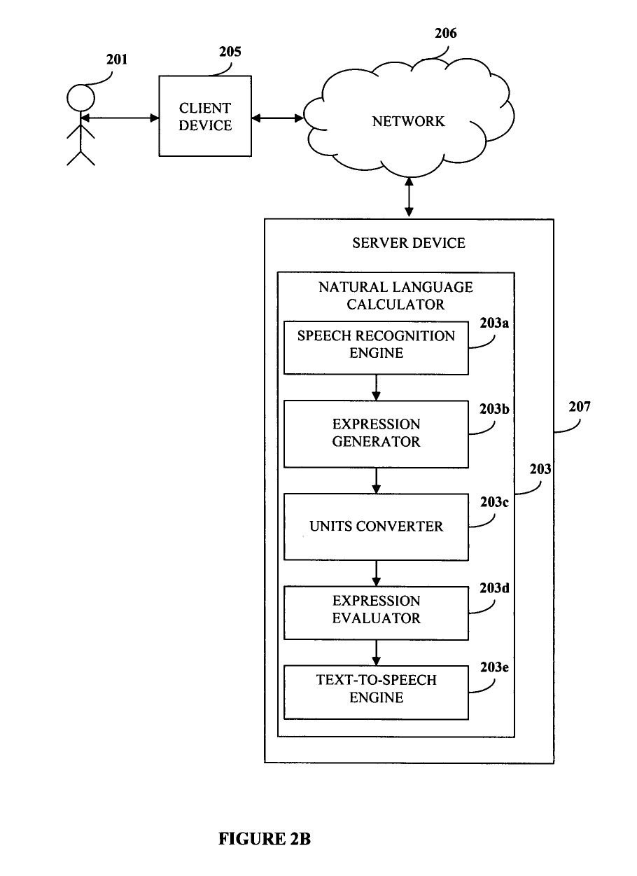

FIG. 2A illustrates a system for evaluating a mathematical expression spoken in a natural language by a user 201. The computer implemented system disclosed herein comprises an audio input device 202, a natural language speech recognition calculator 203, and an output device 204. The user 201 utters a mathematical expression spoken in a natural language into a microphone. The microphone may be designed for speech recognition applications and automatic noise-canceling technology. The microphone converts the utterance of the user 201 into an electrical signal. The microphone is connected to a speech recognition engine 203a of the natural language speech recognition calculator 203 via the audio input device 202. The audio input device 202 converts the electrical speech signal into a digital speech signal suitable for processing by a computing device. The natural language speech recognition calculator 203 may be deployed on a plurality of computing devices, wherein the plurality of computing devices comprises personal computers, personal digital assistants, mobile phones, digital watches, automobile computers, automated teller machines, or dedicated electronic devices such as hand held calculators.

The natural language speech recognition calculator 203 comprises a speech recognition engine 203a, an expression generator 203b, a units converter 203c, an expression evaluator 203d, and a text-to-speech engine 203e. The digitized speech signal from the audio input device 202 is transferred to the speech recognition engine 203a of the natural language speech recognition calculator 203. The speech recognition engine 203a accepts the continuous speech patterns and generates the sequence of words in a natural language selected by the user 201. The user 201 may select a natural language from a plurality of natural languages to enable the speech recognition engine 203a to recognize the language of words of the spoken mathematical expression. If a natural language is not selected, the speech recognition engine 203a may utilize the default natural language. A user-dependent speech profile may also be selected from a plurality of speech profiles to improve the accuracy of speech recognition. The plurality of speech profiles comprise speech recognition parameters saved for a particular user 201 from earlier speech profiles. The user-dependent speech profile comprises parameters related to the speech patterns of the user 201. If a user 201 dependent speech profile is not selected, the speech recognition engine 203a may utilize built-in speech profiles. The user-dependent speech profiles may also be trained in the speech recognition engine 203a by using pre-defined text read by the user 201, or by feeding back recognition errors from the speech recognition engine 203a to the speech profile.

In one embodiment the speech recognition engine 203a may process recorded audio files and text files. The mathematical expression may be one of a recorded speech file, typed text input, or typed text in a text file. The speech recognition engine 203a extracts mathematical entities from the spoken mathematical expression using a speech recognition grammar. The mathematical entities comprise numbers, mathematical operators, and measurement units. The speech recognition grammar implemented by the speech recognition engine 203a provides a hierarchical recursive representation of arbitrary numbers, mathematical operations, and measurement units as described in the detailed description of FIG. 3.

A symbolic mathematical expression is then generated from the extracted mathematical entities using the expression generator 203b. The expression generator 203b parses the symbolic mathematical expression using a standard algorithm, for example, the shunting yard algorithm. The shunting yard algorithm parses mathematical equations specified in a common arithmetic and logical formula notation. This algorithm converts the symbolic mathematical expression into the reverse polish notation (RPN). The parsed symbolic mathematical expression is then normalized with common measurement units using the units converter 203c. The units converter 203c recognizes measurement units such as ‘dollars’, ‘pounds’, ‘miles’, ‘hour’, etc. in the spoken mathematical expression, and verifies the units for compatibility, converts the compatible units to common measurement units, and then checks for derived units as explained in the detailed description of FIG. 1.

The expression evaluator 203d then evaluates the normalized mathematical expression to generate a mathematical result. The mathematical result may be converted to a voice output by a text-to-speech engine 203e. The text-to-speech engine 203e converts digitized text into synthesized speech signals in the natural language selected for the text-to-speech engine 203e. The text-to-speech engine 203e may support a number of natural languages such as English, French, Spanish, Japanese, and Chinese etc. as well as different types of voices including adult male and female voices with different accents, children's voices, and artificial-sounding voices appropriate to robots and other characters. A built-in default language is used if the user 201 does not specifically select a natural language for speech output.

The mathematical result may be provided to the user 201 on an output device 204, wherein the output device 204 is one of an audio output device, a video display unit, a printer, and an electronic device in a network 206. The audio output device converts digitized sound into electrical signals suitable for driving an attached speaker or a headphone. Sound signals generated by the text-to-speech engine 203e produce synthesized speech through the audio output device, speaker or headphones. The video display device may be one of a liquid crystal display screen, a plasma display, a thin film transistor display etc. The mathematical result may be provided to the user 201 through a network port communicating with other electronic devices over a network 206. Depending on the electronic device, the network port may support hardwired or wireless Ethernet, Bluetooth™, Infrared Data Association (IrDA), a cellular phone radio signal, or a satellite communications link.

FIG. 2B illustrates a client-server embodiment of the system for evaluating a mathematical expression spoken in a natural language by a user 201. The disclosed system comprises a client device 205 in communication with a network 206, and a server device 207 implementing the natural language speech recognition calculator 203. The client device 205 may be one of a personal computer, a personal digital assistant, a mobile phone, an automobile computer, an automated teller machine, or a standard residential or business telephone, etc. The client device 205 may include audio input means such as a microphone and output means such as a video display, a speaker, a headphone, etc.

The client device 205 communicates with the server device 207 via the network 206. The client device 205 may communicate with the network 206 using any of one of a number of standard protocols such as wired or wireless Ethernet, Bluetooth™, IRDA, a cellular phone radio signal, a satellite communications link, or a standard residential or business telephone line. Some client devices may include more than one kind of network port to connect with more than one kind of server device 207. The user 201 utters a mathematical expression spoken in a natural language using the audio input means of the client device 205. The client device 205 transmits the spoken mathematical expression as a query over the network 206 to the server device 207. The client query may typically be a digitized representation of the spoken mathematical expression. On a standard analog phone line, the client query may be an analog electrical representation of the voice utterance containing the spoken mathematical expression.

The natural language speech recognition calculator 203 as explained in the detailed description of FIG. 2A is implemented on the server device 207. The server device 207 comprises a database for storing the user 201 dependent speech profiles, and the speech recognition grammar. The server device 207 processes the client query and generates the mathematical result. The mathematical result is generated as explained in the detailed description of FIG. 2A. The mathematical result is then transmitted as a query result back to the client device 205 via the network 206. The server response may take the form of digitized synthesized speech or a text message. On a standard analog phone line, the server response may be an analog electrical representation of the synthesized speech comprising the mathematical result of the spoken mathematical expression. The client device 205 receives the server response in the form of synthesized speech or a text message or a combination thereof. Synthesized speech may be sent to a speaker or a headphone attached to the client device 205. A text message form of the server response may also be sent to the video display device of the client device 205.

Consider an example of the client-server embodiment of the system disclosed herein. Automated telephone voice menu systems used by many businesses utilize both a speech recognition engine 203a to process a spoken menu selection from the caller, and a text-to-speech engine 203e to voice back the instructions or an answer to the caller. In this example, the caller's telephone acts as the client device 205, and a server device 207 at the other end of the line implements the speech recognition and text-to-speech functions. A home user 201 may place a call on their telephone to a predetermined phone number. The predetermined phone number connects to a server implementing the natural language speech recognition calculator 203. The caller may then ask, “How many teaspoons are there in a tablespoon?” The server at the other end of the telephone line processes the question using the disclosed method, and then uses the text-to-speech function of the text-to-speech engine 203e to voice the answer back to the caller.

FIG. 3 illustrates an exemplary block diagram of the speech recognition grammar implemented by the speech recognition engine 203a of the natural language speech recognition calculator 203. The speech recognition grammar defines a set of rules and phrase properties to instruct the speech recognition engine 203a to recognize a restricted subset of possible word patterns. The speech recognition grammar represents mathematical operations using a hierarchical recursive structure. A phrase corresponding to a spoken mathematical expression may be broken down into a series of operations, wherein each operation comprises a collection of arguments. Each argument further comprises a collection of numbers, units and operators, and each number comprises a collection of digit classes corresponding to different repeated numeric groups, such as tens, hundreds, and thousands etc.

Each element in the hierarchy of operations, arguments, numbers, units, operators etc. may further comprise another hierarchy of the same elements. For example, the spoken mathematical expression “two squared plus sixteen hundred cubed” may be considered as a single operation comprising three other operations, namely ‘two squared’, 'sixteen hundred cubed’ and ‘(two squared) plus (sixteen hundred cubed)’. These three operations may further be decomposed into operators and numbers of a hierarchy. Furthermore, the number ‘sixteen hundred’ may be considered as a product of two number groups, namely ‘16’—the ‘teens’ group, and ‘100’—the ‘hundreds’ group. In this manner, the number sixteen hundred is recursively defined in terms of other numbers.

The speech recognition grammar instructs the speech recognition engine 203a to recognize a restricted subset of word patterns. For example, if only the names of three specific people are desired to be recognized, the speech recognition grammar may contain a rule as shown below:

<RULE NAME=“PERSON”>
<LIST PROPNAME=“RELATIONSHIP”>
<P VALSTR=“BROTHER”>Joe</P>
<P VALSTR=“SISTER”>Susan</P>
<P VALSTR=“FRIEND”>Pierre</P>
</LIST>
</RULE>

The above rule instructs the speech recognition engine 203a to detect any one of the words ‘Joe’, ‘Susan’ or ‘Pierre’. The rule name is ‘PERSON’, the list property name is ‘RELATIONSHIP’, and a different property value, namely VALSTR is assigned to each of the words to be matched. When the speech recognition engine 203a detects the word ‘Susan’, then the calling program will be notified that the rule named ‘PERSON’ has been matched and that the ‘RELATIONSHIP’ property has the value ‘SISTER’. The actual word matched, in this case ‘Susan’, will also be returned.

Rules in the speech recognition grammar may refer to other rules in order to perform sophisticated pattern matching on the speech input with a few lines of code. For example, the rule provided by the speech recognition grammar of the computer implemented method disclosed herein detects an arbitrary mathematical operation 301 in the spoken mathematical expression as follows:

<RULE NAME=“OPERATION”>
<LIST>
<P><RULEREF NAME=“UNARY BEFORE” /></P>
<P><RULEREF NAME=“NUMBER” /></P>
<P><RULEREF NAME=“UNITS” /></P>
<P><RULEREF NAME=“UNARY AFTER” /></P>
<P><RULEREF NAME=“BINARY” /></P>
</LIST>
<O><RULEREF NAME=“OPERATION” /></O>
</RULE>

Each element of the rule above refers to another rule in the speech recognition grammar. For example, the element ‘<RULEREF NAME=“UNARY AFTER”/>’ uses the keyword ‘RULEREF’ to refer to another rule named ‘UNARY AFTER’. The ‘UNARY AFTER’ rule may be represented as follows:

<RULE NAME=“UNARY AFTER”>
<LIST PROPNAME=“UNARY AFTER”>
<P VALSTR=“\hat{ }2”>squared</P>
<P VALSTR=“\hat{ }3”>cubed</P>
<P VALSTR=“!”>factorial</P>
</LIST>
</RULE>

The mathematical operations ‘squared’, ‘cubed’, and ‘factorial’ may appear after an argument in a spoken mathematical expression, such as “What is eighteen cubed?”. Therefore, the ‘UNARY AFTER’ rule matches the words ‘squared’, ‘cubed’ and ‘factorial’, since these words are the three mathematical operations following an argument in a spoken mathematical expression. The same grammar rule may also specify which value or string may be sent back to the program when the rule is matched. In the case of the ‘UNARY AFTER’ rule shown above, the string ‘̂3’ is sent back to the program if the word ‘cubed’ is detected since ‘̂3’ is the symbolic expression indicating a number should be raised to a power of 3.

As illustrated in FIG. 3, the speech recognition grammar begins with the specification of a speech grammar rule for a mathematical operation 301. The rule is defined in terms of additional rules for numbers, measurement units, and mathematical operators. The speech grammar rules for a mathematical operation 301 include the following:
Rule 302: a <NUMBER> rule for matching arbitrary numbers such as ‘negative twelve thousand four hundred and fifty six point three four eight (−12,456.348).
Rule 302a: a <DIGIT> rule for matching the spoken digits ‘zero’ through ‘nine’ and mapping the spoken digits to their numeric values 0-9.
Rule 302b: a <TEEN> rule for matching the spoken teens ‘ten’ through ‘nineteen’ and mapping spoken teens to their numeric values 10-19.
Rule 302c: a <TENS> rule for matching the spoken tens numbers ‘twenty’ through ‘ninety’ and mapping the spoken tens to their numeric values 20-90.
Rule 302d: a <POWER> rule for matching the spoken numbers ‘hundred’, ‘thousand’, ‘million’, ‘billion’ etc. and mapping the spoken numbers to the corresponding power of ten: 2, 3, 6, 9, etc.
Rule 302e: a <DECIMAL> rule for matching words indicating a decimal point such as ‘decimal’ and ‘point’.
Rule 302f: a <FRACTION> rule for matching the spoken fractions ‘half’, ‘third’, ‘quarter’, etc. and mapping the spoken fractions to their numeric values ½, ⅓, ¼, etc.
Rule 302g: an <ORDINAL> rule for matching the spoken ordinal numbers ‘first’, ‘second’, ‘third’ etc. and mapping the spoken ordinal numbers into the corresponding numeric equivalents 1, 2, 3, etc.
Rule 302h: a <SPECIAL> rule for matching the spoken special numbers such as ‘pi’ and ‘e’ and mapping the spoken special numbers to their numeric equivalents 3.1415 . . . and 2.718 . . . .
Rule 302i: a <COMPLEX> rule for matching the spoken form of complex numbers such as ‘five plus three i’ and mapping the spoken form of complex numbers to their numeric equivalents (5+3i).
Rule 302j: a speech grammar rule for a recursive reference to the rule for an arbitrary number.
   The speech grammar rule for mathematical operations is augmented by two processing algorithms given by Rule 303 and Rule 304:
Rule 303: a number builder algorithm for computing the value of a number from its recursively defined components.
Rule 304: a concatenator for combining the various operations recognized in the spoken mathematical expression.
Rule 305: a <UNITS> rule for matching words for measurement units such as ‘pounds’, ‘feet’, ‘dollars’, etc. This speech grammar rule 305 may be further broken down into Rule 305a.
Rule 305a: The <UNITS> 305 rule is composed of a set of speech grammar rules for a list of measurement unit names such as ‘pounds’, ‘dollars’, ‘meters, etc.
Rule 306: a <BINARY OPERATOR> rule for matching the names of binary operators requiring two arguments such as ‘twelve <DIVIDED BY> nineteen’. This speech grammar rule 306 may be further broken down into Rule 306a.
Rule 306a: The <BINARY OPERATOR> 306 rule is composed of a set of speech grammar rules for a list of binary operator names such as ‘plus’, ‘divided by’, ‘to the power of’, etc.
Rule 307: a <CONVERT> rule for matching phrases representing a request to explicitly convert between measurement units such as ‘how many feet <ARE THERE IN> two meters’. This speech grammar rule 307 may be further broken down into Rule 307a.
Rule 307a: The <CONVERT> 307 rule is composed of a set of speech grammar rules for a list of phrases requesting the conversion of one unit to another such as ‘Convert A to B’ or ‘How many A are there in <NUMBER> 302 B?’
Rule 308: a speech grammar rule for a recursive reference to the rule for an operation such as ‘five divided by the square root of fourteen’.
Rule 309: a <UNARY BEFORE OPERATOR> rule for matching the names of unary operators appearing before an argument such as ‘the <SQUARE ROOT OF> ten’. This speech grammar rule 309 may be further broken down into Rule 309a.
Rule 309a: The <UNARY BEFORE OPERATOR> 309 rule is composed of a set of speech grammar rules for a list of pre-argument unary operator names such as ‘square root’, ‘tangent’, ‘inverse’, etc.
Rule 310: a <UNARY AFTER OPERATOR> rule for matching the names of unary operators appearing after an argument such as ‘six <CUBED>’. This speech grammar rule 310 may be further broken down into Rule 310a.
Rule 310a: The <UNARY AFTER OPERATOR> 310 rule is composed of set of speech grammar rules for a list of post-argument unary operator names such as ‘squared’, ‘cubed’, ‘factorial’, etc.
Rule 311: a <QUESTION WORDS> rule for detecting the beginning of the spoken mathematical expression in the voice command of the user 201 before the actual operation is uttered by the user 201.

The speech recognition grammar implemented by the speech recognition engine 203a enables the same mathematical operation to be specified in different natural language phrases by the user 201. For example, the grammar rule for the <BINARY OPERATOR> 306 is shown below:

<RULE NAME=“BINARY” EXPORT=“True”>
<LIST PROPNAME=“BINARY”>
<P VALSTR=“+”>plus</P>
<P VALSTR=“+”>added to</P>
<P VALSTR=“and”>and</P>
<P VALSTR=“−”>minus</P>
<P VALSTR=“−”>take away</P>
<P VALSTR=“MINUS_FROM”>taken away from</P>
<P VALSTR=“×”>times</P>
<P VALSTR=“×”>multiplied by</P>
<P VALSTR=“×”>of</P>
<P VALSTR=“/”>divided by</P>
<P VALSTR=“/”>over</P>
<P VALSTR=“/”>by</P>
<P VALSTR=“DIVIDED_INTO”>divided into</P>
<P VALSTR=“\hat{ }”>to the power of</P>
<P VALSTR=“\hat{ }”>raised to the power of</P>
<P VALSTR=“%”> percent of</P>
</LIST>
</RULE>

Consider the spoken mathematical expressions “What is three divided by five?”, “Compute ten over two point six.”, and “How much is twelve by seventy-two?” The property lines for the division operator ‘/’ as shown in the <BINARY OPERATOR> 306 rule matches the three different spoken phrase elements ‘divided by’, ‘over’, and ‘by’ of the spoken mathematical expressions. If another expression for a division operation is specified, a line for the division operator is added to the <BINARY OPERATOR> 306 rule.

Since a given mathematical question may be spoken in different ways using natural language, a <QUESTION WORDS> 311 rule may be used to detect the beginning of a spoken mathematical expression before the actual operation is uttered by the user 201. An exemplary grammar rule for the <QUESTION WORDS> 311 is shown below:

<RULE NAME=“Calculator” TOPLEVEL=“ACTIVE”>
<LIST PROPNAME=“Action”>
<P VALSTR=“Calculator”>compute</P>
<P VALSTR=“Calculator”>calculate</P>
<P VALSTR=“Calculator”>what is</P>
<P VALSTR=“Calculator”>what's</P>
<P VALSTR=“Calculator”>how about</P>
<P VALSTR=“Calculator”>tell me</P>
<P VALSTR=“Calculator”>how much is</P>
</LIST>
</P>
<RULEREF NAME=“Operation” />
</P>
</RULE>

The language specific components of the mathematical expressions are determined by the phrase elements specified in the speech recognition grammar. Therefore, the language of operation may be changed by substituting the appropriate property phrases in the grammar data file. For example, in French, the words for division are ‘divisé’, ‘sur’ and ‘par’. The three property lines for division in the speech recognition grammar file therefore becomes:

<P VALSTR=“/”>divisé</P>
<P VALSTR=“/”>sur</P>
<P VALSTR=“/”>par</P>

Similar substitutions for the other phrase elements in the speech recognition grammar file may be made and hence the disclosed natural language speech recognition calculator 203 may perform any calculation in French or other natural languages instead of English.

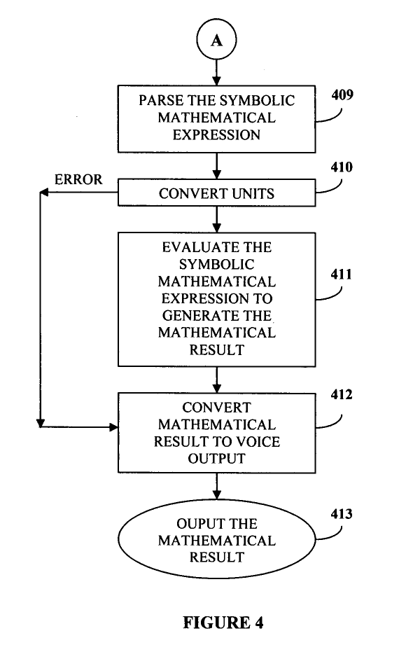

FIG. 4 illustrates an exemplary flowchart of the processes involved in evaluating a mathematical expression spoken in a natural language by a user 201. The process begins with the spoken mathematical expression as the input 401. For illustrating the processes involved, consider the spoken mathematical expression, “How much is three hundred and twenty three point six miles plus ninety five point seven kilometers divided by the square root of two hours?” Using standard library calls to the speech recognition engine 203a, the spoken mathematical expression is processed into a sequence of words, referred to as a phrase. This phrase remains consistent with the utterance. The set of all valid phrases to be recognized by the speech recognition engine 203a is constrained by the rules specified in the speech recognition grammar as explained in the detailed description of FIG. 3. By implementing the speech recognition grammar 402, the example spoken mathematical expression matches the respective rules as follows:

How much is: <QUESTION WORDS> 311
three hundred and twenty three point six: <NUMBER> 302
miles: <UNITS> 305
plus: <BINARY OPERATOR> 306
ninety five point seven: <NUMBER> 302
kilometers: <UNITS> 305
divided by: <BINARY OPERATOR> 306
the square root of: <UNARY BEFORE OPERATOR> 309
two: <NUMBER> 302
hours: <UNITS> 305

As illustrated in FIG. 4, if the grammar rules are not matched 403 in the voiced utterance, a recognition failure occurs and the program notifies 404 the user 201, discards 404 the result, or uses 404 the error to train a user 201 dependent speech profile for future improved recognition performance. If a grammar rule is matched 403 with a phrase of the spoken mathematical expression, the phrase properties in the spoken mathematical expression will be identified 405. In the considered example, the phrases of the spoken mathematical expression match certain rules of the speech recognition grammar. Therefore, the following phrase properties will be identified:

The words ‘three hundred and twenty three point six’ match the <NUMBER> 302 grammar rule comprising the following sub-rules and properties:

three: <DIGIT> 302a = 3
hundred: <POWER> 302d = 2
twenty: <TENS> 302c = 20
three: <DIGIT> 302a = 3
point: <DECIMAL> 302e = “.”
six: <DIGIT> 302a = 6

The word ‘miles’ matches the <UNITS> 305 grammar rule with property value ‘miles’:
miles: <UNITS> 305=“miles”
   The word ‘plus’ matches the <BINARY OPERATOR> 306 grammar rule with a property value of ‘+’:
plus: <BINARY OPERATOR> 306=“+”
   The words ‘ninety five point seven’ match the <NUMBER> 302 grammar rule comprising the following sub-rules and properties:

ninety: <TENS> 302c = 90
five: <DIGIT> 302a = 5
point: <DECIMAL> 302e = “.”
seven: <DIGIT> 302a = 7

The word ‘kilometers’ matches the <UNITS> 305 grammar rule with property value ‘kilometers’:
kilometers: <UNITS> 305=“kilometers”
   The words ‘divided by’ match the <BINARY OPERATOR> 306 grammar rule with a property of ‘/’:
divided by: <BINARY OPERATOR> 306=“/”
   The words ‘the square root of’ match the <UNARY BEFORE OPERATOR> 309 grammar rule with a property of ‘SQRT’:
the square root of: <UNARY BEFORE OPERATOR> 309=“SQRT”
   The word ‘two’ matches the <NUMBER> 302 grammar rule comprising the following sub-rules and properties:
two: <DIGIT> 302a=2
   Finally, the word ‘hours’ matches the <UNITS> 305 grammar rule with property value ‘hours’:
hours: <UNITS> 305=“hours”

After the phrase properties have been identified, the phrase properties are looped through 406 as illustrated in FIG. 4. The loop executes one cycle for each phrase property identified in the spoken mathematical expression. Each phrase property is categorized into one of the components of a mathematical operation 301 as defined in the speech recognition grammar. As illustrated in FIG. 4, these categories are: a <UNARY BEFORE OPERATOR> 309, a <UNARY AFTER OPERATOR> 310, a <NUMBER> 302 argument, a measurement <UNITS> 305, a <BINARY OPERATOR> 306 or a request to <CONVERT> 307 between units. In the case of the example, the phrase properties entering the loop are:

<NUMBER> 302 : <DIGIT> 302a = 3, <POWER> 302d = 2,
<TENS> 302c = 20,
<DIGIT> 302a = 3, <DECIMAL> 302e = “.”, <DIGIT> 302a = 6
<UNITS> 305 = “miles”
<BINARY OPERATOR> 306 = “+”
<NUMBER> 302 : <TENS> 302c = 90, <DIGIT> 302a = 5,
<DECIMAL> 302e =
“.”, <DIGIT> 302a = 7
<UNITS> 305 = “kilometers”
<BINARY OPERATOR> 306 = “/”
<UNARY BEFORE OPERATOR> 309 = “SQRT”
<NUMBER> 302 : <DIGIT> 302a = 2
<UNITS> 305 = “hours”

After a phrase property is categorized, the expression generator 203b generates a symbolic mathematical expression 407 from the recognized phrase properties. If a <NUMBER> 302 property is formed from a number of sub-properties, as is the number 323.6 in the current example, then the number must be constructed from its component parts. The number is constructed from its component parts by adding together the individual number components after multiplying each component by the appropriate power of 10 for that number category. For example, the property <POWER> 302d=2 is assigned the value of 100 (10 to the power of 2) before being multiplied by the preceding <DIGIT> 302a=3 and added to the other components (<TENS> 302c=20+<DIGIT> 302a=3) appearing before the decimal point. Similarly, digits occurring after the decimal place are weighted by the appropriate negative power of 10. Therefore, the ‘6’ after the decimal in 323.6 is given the value 6×10̂ (−1) (10 to the power of −1) before being added to the rest of the number. If one of the operator properties is detected, the appropriate symbol must be inserted into the expression. In the case of the current example, the three operator property symbols are ‘+’, ‘/’ and ‘SQRT’ (square root). If a units property is detected, then the appropriate unit name is inserted into the expression. Using the current example, the symbolic mathematical expression from the expression generator 203b is given by:

(323.6 miles+95.7 kilometers)/SQRT (2) hours

The symbolic mathematical expression is then tested for the end of phrase. If the end of the phrase has not been reached 408, another cycle will be looped for each phrase property. If the end of the phrase has been reached 408, the symbolic mathematical expression will be parsed by the expression generator 203b. The symbolic mathematical expression is parsed 409 using a standard algorithm such as the shunting yard algorithm. The shunting yard algorithm converts the symbolic mathematical expression into a reverse polish notation (RPN). RPN accounts for the order and precedence of the mathematical operators involved in the symbolic mathematical expression. In the current example, the parsed symbolic mathematical expression in the RPN is shown below:

323.6 miles 95.7 kilometers+SQRT (2) hours/

The units converter 203c then operates on any measurement units recognized in the spoken mathematical expression. The units converter 203c normalizes the parsed symbolic mathematical expression with common measurement units. If incompatible units are detected, an error message is sent to the output. Units are compatible for addition and subtraction if they can be converted into one another. For example, miles and kilometers are compatible whereas pounds and inches are not compatible. Different units may also be combined in cases of division or multiplication operations. In the current example, the units ‘miles’ and ‘kilometers’ are compatible for addition and the units ‘hours’ are compatible for division with both miles and kilometers. When all the units are compatible, the next step of units conversion will take place. By default, the program uses the first unit recognized in the spoken mathematical expression as the base unit to which other units are converted 410. In the current example, the first unit is ‘miles’. Therefore, the second unit ‘kilometers’ is converted into miles before the two corresponding values are added. Conversion between units may be performed using a lookup table. Using an approximate conversion factor of 0.62137 for converting kilometers into miles, the parsed symbolic mathematical expression becomes:

323.6 miles 59.465 miles+SQRT (2) hours/

Since the third unit recognized in the example, namely ‘hours’, occurs after a division operation, the third unit is combined with the base unit ‘miles’ into the appropriate derived unit of ‘miles per hour’. The derived unit ‘miles per hour’ becomes the default unit for the mathematical result. The units converter 203c may also respond to specific conversion instructions in the original spoken mathematical expression. For example, if the original voiced utterance was “How much is three hundred and twenty three point six miles plus nine five point seven kilometers divided by the square root of two hours in meters per second?”, then the units converter 203c sets a flag to convert the final result from ‘miles per hour’ into ‘meters per second’ before sending the mathematical result to the output device 204.

The normalized mathematical expression is then evaluated 411 by the expression evaluator 203d to generate the mathematical result. The normalized mathematical expression is evaluated using the built-in mathematical functions of the underlying programming language. If a particular mathematical function is not included in the programming language, then it is added to the expression evaluator 203d as a custom function. The normalized mathematical expression may also be off-loaded to a server device 207, if the client device 205 on which the process is running does not support the required mathematical operations. The client-server embodiment of the disclosed system is illustrated in FIG. 2B.

The result of evaluating the normalized mathematical expression ‘323.6 miles 59.465 miles+SQRT(2) hours/’ is ‘270.868’. From the output of the units converter 203c, the unit of the result is ‘miles per hour’, thereby generating the mathematical result of ‘270.868 miles per hour’. The number of decimal places in the mathematical result may be set as a preference by the user 201, or it may be automatically adjusted according to the number of decimal places in the arguments. The mathematical result is then transferred to the text-to-speech engine 203e. The text-to-speech engine 203e synthesizes a voice output 412 from the mathematical result. The mathematical result 413 is then provided to the user 201 on an output device 204 such as an audio output device. The mathematical result may also be provided to the user 201 on one of a video display unit, a printer, and an electronic device in a network 206.

An embodiment of the computer implemented method and system disclosed herein utilizes a processing device supporting an operating system (OS) and a speech software development kit (SDK). The operating system and SDK together implement the natural language speech recognition calculator 203. The operating systems supported may be one of Microsoft Windows® of Microsoft Corporation, Mac OS X of Apple Inc., Linux OS, Palm OS® of Palm Inc., Windows Mobile® of Microsoft Corporation or Symbian OS™ for mobile devices such as mobile phones. The speech SDKs may be one of Microsoft® speech SDK of Microsoft Corporation, and speech SDKs from Nuance Communications Inc., IBM®, and Sensory Inc. The speech SDK also comprises a speech recognition engine 203a and a text-to-speech engine 203e.

Alternative processing devices implementing the natural language speech recognition calculator 203 may be one of personal computers (PCs), personal digital assistants (PDAs), mobile phones, automobile computers, and automated teller machines (ATMs). Speech SDKs comprising speech recognition engines 203a and text-to-speech engines are available for all types of personal computers including PCs running on Microsoft Windows®, computers running Mac OS X of Apple Inc., and computers running on Linux OS and other versions of UNIX. These platforms also support a variety of programming languages, such as C++, used for programming the routines specified by the natural language speech recognition calculator 203. For PCs running on Microsoft Windows®, a number of speech SDKs are available including Speech SDK 5.1 of Microsoft Corporation, Dragon Naturally Speaking SDK 9 from Nuance Communications Inc., and the FluentSoft™ Speech SDK from Sensory Inc. For computers running Mac OS X of Apple Inc., Apple provides the Carbon developer kit that includes a speech SDK compatible with Apple's Speech Recognition Manager and Speech Synthesis Manager. For Linux computers, speech SDKs include ViaVoice from IBM®, the FluentSoft™ Speech SDK from Sensory Inc., and open source development kits such as Julius and Open Mind Speech.

Speech SDKs are available for hand held PDAs such as the Treo™ of Palm Inc., and Pocket PC of Microsoft Corporation. These devices utilize an operating system designed for PDAs including Palm OS® of Palm Inc., and Windows Mobile® of Microsoft Corporation. Speech SDKs are available for these operating systems. In particular, Sensory Inc. makes a speech SDK for Palm OS® and Windows Mobile® PDAs. Many mobile phones including phones from Nokia Corporation, Motorola Inc., Samsung Electronics, Sony Ericsson, freedom of mobile multimedia access (FOMA) of NTT DoCoMo, Inc. etc., use the Symbian OS™. Furthermore, Sensory Inc. makes a speech SDK for the Symbian OS™ comprising both the speech recognition engine 203a and the text-to-speech engine 203e. Both Sensory Inc. and IBM® have developed speech SDKs for the embedded speech devices that are typically used in automobile computers and ATMs. These devices may therefore be programmed to implement the natural language speech recognition calculator 203.

An alternative embodiment of the computer implemented method and system disclosed herein utilize speech recognition devices without using an operating system as described earlier. For example, Sensory Inc. manufactures specialized speech hardware modules such as the RSC-4X speech processor and the voice recognition VR Stamp™ development module. These modules include both speech recognition and text-to-speech capabilities embedded directly on an integrated circuit (IC). The modules also include a microprocessor and Electrically Erasable Programmable Read Only Memory (EEPROM) programmed using the libraries, C compiler, and FluentChip™ of Sensory Inc. A microphone input and speaker or headphone output may also be integrated on these platforms. These devices are therefore ideally suited to implement the natural language speech recognition calculator 203. In particular, such a module may be used as a standalone voice-based calculating device, similar to a traditional hand held calculator processing spoken mathematical questions and voicing back the answer using synthesized speech. Similar hardware speech modules may be used to embed the natural language speech recognition calculator 203 into speech-enabled toys, digital watches, or novelty desktop devices.

Mobile phone users also utilize client-server speech services. An example of these services is the wireless Voice Control and Nuance Narrator provided by Nuance Communications Inc. These services are also provided by Sprint Nextel. The Voice Control service is available for a number of brands of mobile phones or PDAs including models from Blackberry®, Palm Inc., Sprint Nextel, and Motorola Inc. Using the Voice Control service, the user 201 of one of these phones may use natural voice commands to dial phone numbers, dictate e-mail messages, or browse the web. Using a setup similar to the client-server configuration illustrated in FIG. 2B, the client devices send voice utterances spoken by the user 201 back to a server device 207 over the wireless network of the service provider. The server device 207 then processes the voice utterance using the speech recognition engine 203a of the natural language speech recognition calculator 203 implemented on the server device 207. The appropriate result is then sent back to the mobile phone of the user 201. For example, if the user 201 utters the phrase “Call John Smith”, the server device 207 uses the speech recognition engine 203a to match the name “John Smith” against the user's 201 address book, and then returns the appropriate phone number to the mobile phone for dialing. If the Nuance Narrator service of Nuance Communications Inc. is also used, the server may convert the text results or incoming e-mail messages to synthesized speech using the text-to-speech engine 203e of the natural language speech recognition calculator 203. The client-server embodiment of the disclosed system may also be implemented using personal computers, automobile computers, ATMs, and dedicated or embedded devices connected to the network 206.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the database included in the client-server embodiment of the invention, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of evaluating a mathematical expression spoken in a natural language by a user, comprising the steps of:
providing a natural language speech recognition calculator comprising a speech recognition engine, wherein said speech recognition engine implements a speech recognition grammar;
representing mathematical entities of said spoken mathematical expression in a hierarchical recursive structure of said speech recognition grammar;
generating a mathematical result from the spoken mathematical expression using said natural language speech recognition calculator, comprising the steps of:
extracting said mathematical entities from the spoken mathematical expression using the speech recognition grammar of the speech recognition engine;
generating a symbolic mathematical expression from said extracted mathematical entities;
normalizing said symbolic mathematical expression with common measurement units; and
evaluating said normalized mathematical expression to generate said mathematical result.

2. The computer implemented method of claim 1, wherein said natural language of the spoken mathematical expression is selected from a plurality of natural languages provided by the speech recognition engine.

3. The computer implemented method of claim 1, wherein the speech recognition engine utilizes a plurality of speech profiles for improving the accuracy of speech recognition.

4. The computer implemented method of claim 3, wherein each of said plurality of speech profiles is a user dependent speech profile.

5. The computer implemented method of claim 1, wherein the mathematical entities comprise numbers, mathematical operators, and measurement units.

6. The computer implemented method of claim 1, wherein said step of normalizing the symbolic mathematical expression comprises a step of verifying the compatibility of measurement units of the symbolic mathematical expression.

7. The computer implemented method of claim 6, wherein said compatible measurement units are converted to said common measurement units.

8. The computer implemented method of claim 1, wherein the mathematical result is provided to said user as one of a text output, a voice output, a video output, and any combination thereof.

9. The computer implemented method of claim 1, wherein the natural language speech recognition calculator is implemented on a server device.

10. The computer implemented method of claim 9, wherein said server device is accessed by a client device to evaluate the spoken mathematical expression.

11. The computer implemented method of claim 1, wherein the natural language speech recognition calculator is implemented on integrated circuits.

12. The computer implemented method of claim 1, wherein the natural language speech recognition calculator is deployed on a plurality of computing devices, wherein said plurality of computing devices comprises personal computers, personal digital assistants, mobile phones, automobile computers, and automated teller machines.

13. A computer implemented system for evaluating a mathematical expression spoken in a natural language by a user, comprising:
a natural language speech recognition calculator for generating a mathematical result from said spoken mathematical expression, comprising:
a speech recognition engine for implementing a speech recognition grammar to represent mathematical entities of the spoken mathematical expression in a hierarchical recursive format;
an expression generator for generating a symbolic mathematical expression from said mathematical entities;
a units converter for normalizing said symbolic mathematical expression with common measurement units; and
an expression evaluator for evaluating said normalized mathematical expression to generate said mathematical result.

14. The computer implemented system of claim 13, wherein an audio input device is provided for accepting the spoken mathematical expression from said user.

15. The computer implemented system of claim 13, wherein a text to speech engine is provided for synthesizing a voice output from the mathematical result.

16. The computer implemented system of claim 13, wherein the mathematical result is provided to said user on an output device, wherein said output device is one of an audio output device, a video display unit, a printer, and an electronic device in a network.

17. A computer program product comprising computer executable instructions embodied in a computer-readable medium, wherein said computer program product comprises:
a first computer parsable program code for implementing a speech recognition grammar of a speech recognition engine for a mathematical expression spoken by a user in a natural language;
a second computer parsable program code for representing mathematical entities of said spoken mathematical expression in a hierarchical recursive format of said speech recognition grammar;
a third computer parsable program code for extracting said mathematical entities from the spoken mathematical expression using the speech recognition grammar of said speech recognition engine;
a fourth computer parsable program code for generating a symbolic mathematical expression from said extracted mathematical entities;
a fifth computer parsable program code for normalizing said symbolic mathematical expression with common measurement units; and
a sixth computer parsable program code for evaluating said normalized mathematical expression to generate a mathematical result.

18. The computer program product of claim 17, further comprising a seventh computer parsable program code for selecting said natural language for the spoken mathematical expression from a plurality of natural languages provided by the speech recognition engine.

19. The computer program product of claim 17, further comprising an eighth computer parsable program code for selecting a speech profile from a plurality of speech profiles to improve the accuracy of speech recognition.

20. The computer program product of claim 17, further comprising a ninth computer parsable program code for verifying the compatibility of measurement units of the symbolic mathematical expression.

21. The computer program product of claim 20, further comprising a tenth computer parsable program code for converting said compatible measurement units to said common measurement units.
